(19) United States
(12) Patent Application Publication
(10) Pub. No.: US 2023/0401732 A1
(43) Pub. Date: Dec. 14, 2023

(54) DYNAMIC CAMERA SELECTION

(71) Applicant: Apple Inc., Cupertino, CA (US)

(72) Inventors: George E. WILLIAMS, Pleasanton, CA (US); Stuart BOWERS, Palo Alto, CA (US); Roddy M. SHULER, Palo Alto, CA (US)

(21) Appl. No.: 18/203,560

(22) Filed: May 30, 2023

Related U.S. Application Data
(60) Provisional application No. 63/350,595, filed on Jun. 9, 2022.

(51) Int. Cl. G06T 7/55; G06T 7/00; H04N 23/90; H04N 23/60; H04N 23/667

(52) U.S. Cl. CPC G06T 7/55; G06T 7/0002; H04N 23/90; H04N 23/64; H04N 23/667; G06T 2207/30168; G06T 2207/20021

(57) ABSTRACT

This disclosure provides more effective and/or efficient techniques for determining information about a physical environment. Such techniques optionally complement or replace other techniques for determining information about a physical environment. Some techniques described herein cover switching which cameras are used to calculate a depth of a location in a physical environment. The switch may occur when current images do not have sufficient feature correlation for calculating the depth of the location. Other techniques described herein cover switching which cameras are used to obtain sufficient data for a location within a representation (e.g., a three-dimensional representation) of a physical environment. The switch may occur in response to determining that there is not sufficient data for the location.

### CROSS-REFERENCE TO RELATED APPLICATIONS

The present application claims benefit of U.S. Provisional Patent Application Ser. No. 63/350,595, entitled “DYNAMIC CAMERA SELECTION” filed on Jun. 9, 2022, which is hereby incorporated by reference in its entirety for all purposes.

### BACKGROUND

Some devices include a camera for capturing images of a physical environment to determine information about the physical environment, such as calculating a depth of a location. Such determinations are limited by the images used and/or captured. Accordingly, there is a need to provide more effective and/or efficient techniques for determining information about a physical environment.

### SUMMARY

This disclosure provides more effective and/or efficient techniques for determining information about a physical environment. Such techniques optionally complement or replace other techniques for determining information about a physical environment.

Some techniques described herein cover switching which cameras are used to calculate a depth of a location in a physical environment. The switch may occur when current images do not have sufficient feature correlation for calculating the depth of the location. Other techniques described herein cover switching which cameras are used to obtain sufficient data for a location within a representation (e.g., a three-dimensional representation) of a physical environment. The switch may occur in response to determining that there is not sufficient data for the location.

In techniques described herein, cameras may be in different configurations on a device. For example, three cameras may be positioned in a triangle pattern with two cameras situated on a horizontal axis and the third camera above or below the horizontal axis. For another example, four cameras may be positioned in a rectangle pattern.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating a device for determining information about a physical environment.

FIG. 4A is a block diagram illustrating a camera array of three cameras.

FIG. 4B is a block diagram illustrating a camera array of four cameras.

FIG. 5 is a flow diagram illustrating a method for calculating a depth of a location.

FIG. 6 is a flow diagram illustrating a method for obtaining sufficient data with respect to a physical environment.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

Some techniques described herein cover switching which cameras are used to calculate a depth of a location in a physical environment. The switch may occur when current images do not have sufficient feature correlation for calculating the depth of the location. In one example, a device includes multiple cameras with at least partial overlapping field of views of a physical environment. The device causes a set of cameras to capture images of the physical environment. The images are then used to attempt to calculate depth of different locations within the images. When the images do not have sufficient feature correlation to calculate a depth of a location, the device causes a different set of cameras to capture images of the physical environment. The images captured by the different set are then used to calculate the depth of the location. The different set may or may not include a camera from the original set of cameras. In some examples, the different set of cameras are selected from multiple possible different sets of cameras. In some examples, in response to images not having sufficient feature correlation, the device causes a single camera to capture multiple images to be used to calculate the depth of the location.

Other techniques described herein cover switching which cameras are used to obtain sufficient data for a location within a representation of a physical environment. The switch may occur in response to determining that there is not sufficient data for the location. In one example, a device includes multiple cameras with at least partial overlapping field of views of a physical environment. The device causes a set of cameras to capture images of the physical environment. The images are used to generate a depth map of the physical environment, the depth map including distances for different locations in the physical environment. In some examples, the depth map and the images are used to generate a representation of the physical environment, the representation including locations of identified objects within the physical environment. The device then determines that the representation does not include sufficient data for a particular location. For example, the set of cameras might not be able to capture an image of the particular location. After determining the shortcoming of the representation, the device causes a different set of one or more cameras to capture images of the physical environment.

In techniques described herein, the multiple cameras may be in different configurations on a device. For example, the multiple cameras may include three cameras that are positioned in a triangle pattern with two cameras situated on a horizontal axis and the third camera above or below the horizontal axis. Such a configuration may allow for switching a camera with another camera when an issue arises. For another example, the multiple cameras may include four cameras that are positioned in a rectangle pattern. Such a configuration may allow for switching a current pair of cameras with a particular distance between the current pair to a new pair of cameras with a different distance between the new pair.

In methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some examples, these terms are used to distinguish one element from another. For example, a first device could be termed a second device, and, similarly, a second device could be termed a first device, without departing from the scope of the various described embodiments. In some examples, the first device and the second device are two separate references to the same device. In some embodiments, the first device and the second device are both devices, but they are not the same device or the same type of device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

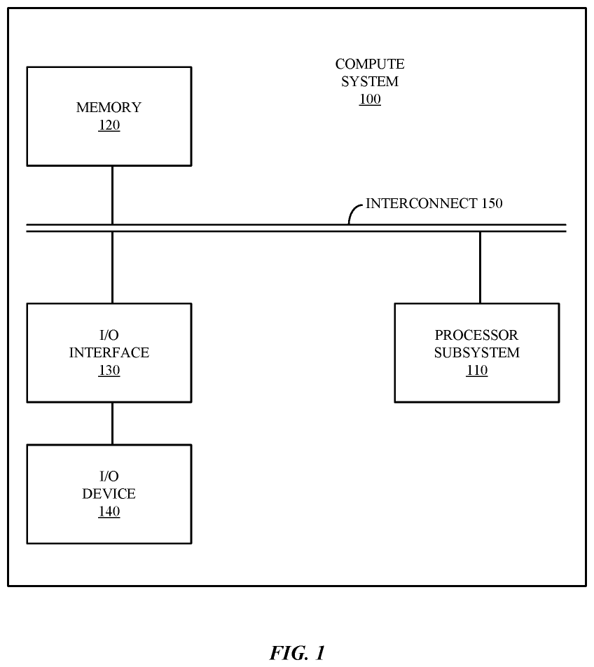

Turning now to FIG. 1, a block diagram of compute system 100 is depicted. Compute system 100 is a non-limiting example of a compute system that may be used to perform functionality described herein. It should be recognized that other computer architectures of a compute system may be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there may be one or more I/O interfaces, with each I/O interface coupled to one or more I/O devices. In some examples, multiple instances of processor subsystem 110 may be coupled to interconnect 150.

Compute system 100 may be any of various types of devices, including, but not limited to, a system on a chip, a server system, a personal computer system (e.g., an iPhone, iPad, or MacBook), a sensor, or the like. In some examples, compute system 100 is included with or coupled to a physical component for the purpose of modifying the physical component in response to an instruction (e.g., compute system 100 receives an instruction to modify a physical component and, in response to the instruction, causes the physical component to be modified (e.g., through an actuator)). Examples of such physical components include an acceleration control, a break, a gear box, a motor, a pump, a refrigeration system, a suspension system, a steering control, a vacuum system, a valve, or the like. As used herein, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, a camera, an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. Although a single compute system is shown in FIG. 1, compute system 100 may also be implemented as two or more compute systems operating together.

In some examples, processor subsystem 110 includes one or more processors or processing units configured to execute program instructions to perform functionality described herein. For example, processor subsystem 110 may execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that are to be executed by processor subsystem 110. In such examples, the priority assigned to a task is used to identify a next task to execute. In some examples, the priority-based scheduler identifies a next task to execute when a previous task finishes executing (e.g., the highest priority task runs to completion unless another higher priority task is made ready).

In some examples, the middleware system provides one or more services and/or capabilities to applications (e.g., the one or more applications running on processor subsystem 110) outside of what is offered by the operating system (e.g., data management, application services, messaging, authentication, API management, or the like). In some examples, the middleware system is designed for a heterogeneous computer cluster, to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), ZeroMQ. In some examples, the middleware system represents processes and/or operations using a graph architecture, where processing takes place in nodes that may receive, post, and multiplex sensor data, control, state, planning, actuator, and other messages. In such examples, an application (e.g., an application executing on processor subsystem 110 as described above) may be defined using the graph architecture such that different operations of the application are included with different nodes in the graph architecture.

In some examples, a message is sent from a first node in a graph architecture to a second node in the graph architecture using a publish-subscribe model, where the first node publishes data on a channel in which the second node is able to subscribe. In such examples, the first node may store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

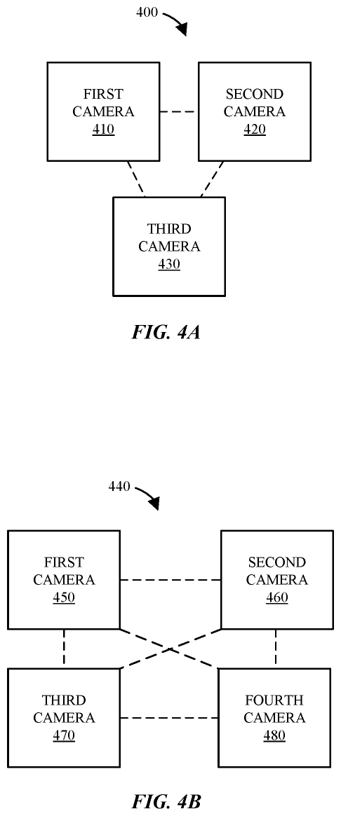

Memory 120 may include a computer readable medium (e.g., non-transitory or transitory computer readable medium) usable to store program instructions executable by processor subsystem 110 to cause compute system 100 to perform various operations described herein. For example, memory 120 may store program instructions to implement the functionality associated with the flow described in FIGS. 4 and/or 5.

Memory 120 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Rather, compute system 100 may also include other forms of storage such as cache memory in processor subsystem 110 and secondary storage on I/O device 140 (e.g., a hard drive, storage array, etc.). In some examples, these other forms of storage may also store program instructions executable by processor subsystem 110 to perform operations described herein. In some examples, processor subsystem 110 (or each processor within processor subsystem 110) contains a cache or other form of on-board memory.

I/O interface 130 may be any of various types of interfaces configured to couple to and communicate with other devices. In some examples, I/O interface 130 includes a bridge chip (e.g., Southbridge) from a front-side bus to one or more back-side buses. I/O interface 130 may be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like).

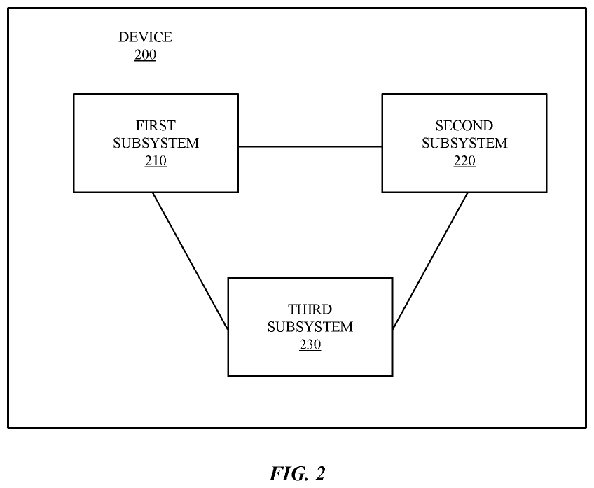

FIG. 2 depicts a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other. An example of a possible computer architecture of a subsystem as included in FIG. 2 is described in FIG. 1 (i.e., compute system 100). Although three subsystems are shown in FIG. 2, device 200 may include more or fewer subsystems.

In some examples, some subsystems are not connected to another subsystem (e.g., first subsystem 210 may be connected to second subsystem 220 and third subsystem 230 but second subsystem 220 may not be connected to third subsystem 230). In some examples, some subsystems are connected via one or more wires while other subsystems are wirelessly connected. In some examples, one or more subsystems are wirelessly connected to one or more compute systems outside of device 200, such as a server system. In such examples, the subsystem may be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), a vehicle, or the like. In some examples, device 200 is configured to navigate device 200 (with or without direct user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 may each be a camera that is capturing images for third subsystem 230 to use to make a decision. In some examples, at least a portion of device 200 functions as a distributed compute system. For example, a task may be split into different portions, where a first portion is executed by first subsystem 210 and a second portion is executed by second subsystem 220.

Attention is now directed towards techniques for determining information about a physical environment using an example of a device with cameras capturing images of the physical environment. In some examples, the device determines that there is a lack of feature correlation between images from a current set of cameras and selects a different set of cameras to use to achieve sufficient feature correlation. In other examples, the device determines that there is insufficient information in a representation of the physical environment and selects a new set of cameras to use to capture sufficient information to add to the representation. It should be understood that more or fewer cameras (including a single camera) and other types of sensors are within scope of this disclosure and may benefit from techniques described herein.

According to techniques described herein, the device uses sensors to locate objects within the physical environment. Such locating may include estimating (e.g., calculating) a depth (e.g., a distance from the device) of an object (e.g., the object generally or a portion of (e.g., not all of) the object). Different sensors or combinations of sensors may be used to estimate the depth, including cameras and active range sensors (e.g., a light or radio detection and ranging system).

Estimating depth with cameras may use monocular images (e.g., a single camera sensor capturing static or sequential images) or stereo images (e.g., multiple camera sensors capturing static or sequential images). The following techniques for estimating depth may be used in any combination with each other.

One technique for estimating depth uses depth cues to identify relative position of different objects in a physical environment. Examples of depth cues include comparing size of different objects (e.g., objects appear smaller when the objects are farther away), texture (e.g., the texture of objects is less identifiable (e.g., lower quality) when the objects are farther away), shading (e.g., shading of an object may indicate a portion of the object is further away than another portion), linear perspective (e.g., objects converge to the horizon as the objects are farther away), motion parallax (e.g., objects further away appear to move slower than closer objects), binocular parallax (e.g., closer objects have greater disparity between two images than objects further away), and apparent size of a known object (e.g., when a type of an object is identified, the size of the object may be constrained by typical sizes of objects of that type). Using one or more of these depth cues, the technique determines that an object is closer or further away than another object.

Another technique for estimating depth identifies correspondence between two images (e.g., captured using two different image sensors (such as two different cameras) or a single image sensor (such as a single camera) at two different times). The technique then, using geometry (e.g., epipolar geometry), estimates a depth of areas within the images. In one example, estimating depth using correspondence includes identifying a feature (e.g., one or more pixels in an image, such as a corner, an edge, or any distinctive portion of the image) in a first image and identifying a corresponding feature in a second image (e.g., a feature in the second image that is determined to match the feature in the first image). In some examples, such features are identified independently and compared with each other. In other examples, the feature in the first image is used to identify the corresponding feature in the second image. After identifying the features, a difference (sometimes referred to as the shift or disparity) is calculated between where the features are located in their respective images. Based on the disparity, focal lengths of the cameras that captured the images, and the distance between the cameras that captured the images, a depth of the feature is determined. In another example, estimating depth using correspondence includes dividing an image into multiple regions and identifying a number of features in each region. A different image is then compared with the features in each region to find corresponding features. If enough features (e.g., above a threshold) are identified in enough regions (e.g., above a threshold), depth is calculated for an area based on a calibrated model of relative geometric positions of the cameras using a calculated disparity as described above. Accordingly, in such an example, a threshold number of corresponding features are required that are different from the area for which depth is being calculated.

Another technique for estimating depth uses a neural network to estimate depth. For example, a neural network takes an image as input and outputs a depth value based on depth cues, such as a depth cue described above. In some examples, the neural network learns to regress depth from depth cues in images via supervised learning by minimizing a loss function (e.g., a regression loss).

In techniques described herein, one or more cameras may be calibrated before, during or after particular steps are being performed. In some examples, calibration includes a process of determining specific camera parameters to determine an accurate relationship between a three-dimensional point in a physical environment and its corresponding two-dimensional projection (e.g., pixel) in an image. Such parameters remove distortions in images and thereby establish a relation between image pixels and physical environment dimensions. Distortions may be captured by distortion coefficients, whose values reflect the amount of radial (e.g., occurs when light rays bend more at an edge of a lens than an optical center of the lens) and tangential (e.g., occurs when a lens is not parallel with an image plane) distortion in an image. Distortion coefficients include intrinsic parameters (e.g., focal length and optical center) and extrinsic parameters (e.g., rotation and translation of a camera) for each camera. In some examples, extrinsic parameters are used to transfer between world (e.g., physical environment) coordinates and camera coordinates and intrinsic parameters are used to transfer between camera coordinates and pixel coordinates.

Techniques described herein perform calibration using images captured by cameras. For example, the calibration may include comparing an image captured by a first camera with an image captured by a second camera to identify differences to determine distortion coefficients. In such an example, the distortion coefficients are determined by comparing image features captured by the cameras in a controlled environment for which ground truth geometric locations of those features are known. In some examples, the camera used for calibration may or may not be included in a set of cameras used for determining information about the physical environment. For example, a camera not included in the set of cameras may be used to calibrate a camera in the set of cameras, such as to determine distortion coefficients for the camera in the set of cameras.

Techniques described above rely on one or more images capturing an object to determine a depth of the object. Accordingly, some techniques described herein switch from using a first set of images to another set of images, such as images from a different camera that is oriented differently and/or located in a different location from at least some of the cameras used to capture the first set.

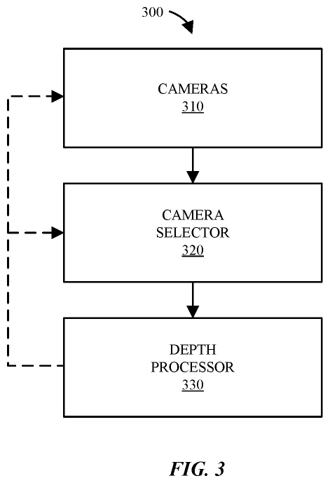

FIG. 3 is a block diagram illustrating device 300 for determining information about a physical environment, according to some techniques described herein. While FIG. 3 is primarily described with respect to calculating depth, it should be understood that similar techniques may be used for other determinations (e.g., identifying, classifying, or determining information about an object or other element in the physical environment).

Device 300 includes multiple subsystems that are at least partially interconnected. For example, device 300 includes multiple cameras (i.e., cameras 310) that are each connected (e.g., wired or wirelessly) to camera selector 320. It should be recognized that one or more subsystems of device 300 may be combined or further broken out into more subsystems. For example, a camera subsystem may include a camera selector and a depth processor or a depth processor may include a camera selector.

In some examples, each camera of cameras 310 is configured to capture an image and either send the image to camera selector 320 or store the image in a particular location specific to each camera. In some examples that a camera is storing the image in a particular location, the camera notifies camera selector 320 that the image has been stored (and optionally includes where the image has been stored through, for example, a pointer to a memory location) and camera selector 320 is configured to access the image where it has been stored. In other examples that a camera is storing the image in a particular location, the camera does not notify camera selector 320 that the image has been stored and instead camera selector 320 requests to access a known location for one or more stored images. As used herein, “sending” an image from one subsystem to another subsystem may refer to either actually sending the image to the other subsystem or storing the image such that the other subsystem may access the image.

In some examples, cameras 310 corresponds to two or more cameras configured to capture images of an at least partial overlapping area in the physical environment. Examples of configurations of cameras 310 are illustrated in FIGS. 4A and 4B, which are further discussed below.

As mentioned above, device 300 includes camera selector 320. Camera selector 320 may be configured to identify one or more cameras from cameras 310 to use for further processing, such as depth processing by depth processor 330. In some examples, camera selector 320 receives images from each camera of cameras 310 and determines which images to send to depth processor 330. In other examples, camera selector 320 receives images from only a subset (e.g., less than all) of cameras of cameras 310 (where the subset is selected by camera selector 320 either before or after camera selector 320 receives any images from a camera of cameras 310) and sends all images received to depth processor 330. In some examples, camera selector 320 causes a camera to capture an image and then sends the captured image to depth processor 330. In some examples, camera selector 320 causes one or more cameras to stop capturing and/or sending images to camera selector 320.

As illustrated in FIG. 3, device 300 further includes depth processor 330. Depth processor 330 may be configured to calculate a depth of a location within the physical environment based on images captured by one or more cameras selected by camera selector 320. In other examples, depth processor 330 is included in a device separate from device 300, such as remote server. Depth processor 330 may calculate the depth using any of the techniques described herein (or any combination thereof). For example, depth processor 330 may (1) receive a first image and a second image, (2) identify a feature in the first image and a corresponding feature in the second image, and (3) calculate a depth of the feature using epipolar geometry.

In some examples, different compute systems (e.g., different systems on a chip executing camera selector 320 and/or depth processor 330) are assigned to receive images from different cameras. For example, a first compute system may be configured to receive images from a first camera and a second camera to determine depth information for a location using images from the first camera and the second camera and another compute system may be configured to receive images from other cameras to determine depth information using the images from the other cameras. In such an example, images may be stored on memory local to the respective compute system to reduce time to access pixel information and/or requirements to send pixel information between compute systems. In another example, a first compute system is configured to receive images from a first camera and store the received images in memory local to the first compute system and a second compute system is configured to receive images from a second camera and store the received images in memory local to the second compute system, where one of the two compute systems is configured to determine depth information using the images from both cameras. In such an example, the compute system not determining depth information may send only a portion (e.g., less than all) of images to the compute system determining depth information to reduce amount of data moving to different compute systems. The portion may correspond to less resolution images and/or just a subset of an image (e.g., some of the image is sent and some of the image is not sent) that is required for computation. In other examples, feature correlation is performed in object space such that objects are identified in a first image and objects are identified in a second image and then objects are compared to each other for determining correspondence between the images. Such a comparison would not require comparing individual pixels.

In some examples, depth processor 330 generates a depth map for the physical environment using the depth calculated for the location. In such examples, the depth map includes depths for different locations within the physical environment. The depth map may then be used by device 300 to make decisions, such as how to navigate the physical environment. As used herein, the depth map is sometimes referred to as a representation of the physical environment. In some examples, depth processor 330 uses other data detected by other types of sensors, in combination with images, to generate the depth map. For example, a light or radio detection and ranging system may be used to identify a depth of a featureless area and/or provide calibration for depth calculations. In such an example, the light or radio detection and ranging system may only capture data for particular areas and/or at particular resolution (e.g., less resolution than an image captured by a camera, such as a camera in a ready mode as described herein).

In some examples, device 300 uses the depth map and one or more images captured by cameras 310 to generate a representation (e.g., a three-dimensional representation or object view) of the physical environment. In such examples, the representation includes additional information (i.e., other than depth) about the physical environment, such as an identification of objects within the physical environment as well as any other information that would help device 300 make decisions with respect to the physical environment. In some examples, other data detected by other types of sensors (e.g., a light or radio detection and ranging system) is used in combination with the images to generate the representation.

In some examples, depth processor 330 is unable to match a particular feature in the first image with a particular feature in the second image. In such examples, a depth of the particular feature is not able to be calculated due to a lack of feature correlation. In other examples, depth processor 330 determines that there is a lack of feature correlation with respect to a subset of the image other than the particular feature. In such examples, the particular location is unable to be located within the physical environment.

In some examples, depth processor 330 sends a message to camera selector 320 in response to determining a lack of feature correlation. The message may include an identification of a location in which the lack of feature correlation is affecting, a confidence level that the lack of feature correlation has occurred, the depth map (or an update to the depth map if, for example, the depth map is managed by or stored in memory local to camera selector 320), the representation generated from the depth map (or an update to the representation if, for example, the representation is managed by or stored in memory local to camera selector 320), an indication that the depth map or the representation generated from the depth map has been updated, or any combination thereof. In other examples, the lack of feature correlation is reflected in the depth map and/or the representation generated from the depth map, which may be accessible by camera selector 320. In some examples, camera selector 320 may be configured to operate at a fixed rate such that camera selector 320 identifies one or more cameras from cameras 310 to use for further processing according to the fixed rate (e.g., every 100 milliseconds).

In response to receiving the message, determining that information related to the physical environment has been updated, or initiating operation, camera selector 320 may determine whether and which one or more cameras to switch to in order to obtain sufficient information. Such a determination may be based on whether (1) there is a lack of feature correlation, (2) a representation of the physical environment is missing depth information for a location, (3) there is no data with respect to a location, (4) there is enough information to classify an object located at a location, (5) a sufficient depth calculation (e.g., a current depth calculation has been determined to not be correct or there is not a depth calculation), (6) an object determined to be in a line of sight of a particular camera such that objects behind the object are hidden, or (7) any combination thereof. In some examples, camera selector 320 performs a geospatial search using the representation to determine an area in which information is needed. The geospatial search may include identifying a portion of the physical environment in which device 300 is moving and determining what portions of the representation are relevant to the area. In some examples, the geospatial search may include may include spatial decomposition of a portion or portions of the physical environment and ranking them in terms of importance to device 300 based on semantic knowledge of the physical environment, such as the location, speed, and heading of device 300 within the physical environment, the location and classification of other objects within the physical environment, and a particular objective. In some examples, selection based on such criteria prioritizes high resolution in a small window in one direction at one time and low resolution in a larger window at another time. In other examples, selection based on such criteria prioritizes depth perception between twenty and one hundred meters at one time and depth resolution between five and twenty five meters at another time.

In some examples, camera selector 320 identifies a portion (e.g., less than all) of the physical environment in which device 300 requires additional information and sends images corresponding to the portion to depth processor 330. In such examples, partial images (e.g., not an entire image) may be sent to depth processor 330 to reduce an amount of data that depth processor 330 needs to process.

In some examples, camera selector 320 determines that depth information for the location is not needed for a current determination needed to be made by device 300. For example, device 300 might be traveling at a speed in which the location is not needed for determinations at this time. For another example, device 300 might identify enough information about the location using information other than an image captured by a camera (e.g., a map received by device 300 or a light or radio detection and ranging system).

In some examples, camera selector 320 determines to select a new set of cameras in response to identifying an issue with a current set of cameras. For example, an issue may include lens flare, veiling glare, occlusion, hardware failure, software failure, a location for which depth calculations are determined to be incorrect, an area in the physical environment not sufficiently covered by the current set of cameras, or the like. In some examples, device 300 continues to navigate the physical environment while attempting to use a different set of one or more cameras to fix the issue.

With more than two cameras, camera selector 320 may form a set of cameras (e.g., a stereo pair consisting of two cameras) between different cameras to capture a portion of the physical environment and/or have redundant sets of cameras to capture the same portion of the physical environment (e.g., multiple stereo pairs covering an at least partially overlapping area). In some examples, having multiple cameras increases availability (e.g., in case of individual camera failure or obstruction) and/or information with respect to the physical environment.

In some examples, a first set of cameras of cameras 310 is established as default (e.g., predefined before device 300 begins executing an application). In such examples, the first set may be changed to a second set of cameras (e.g., the second set may or may not include a camera in the first set) to mitigate the issue determined by camera selector 320. In some examples, the first set and/or the second set is established based on a likelihood that cameras included in the respective set are able to capture an image of a particular location in the physical environment.

In some examples, camera selector 320 determines an optimal set of cameras out of multiple different sets of cameras. In some examples, the optimal set consists of one or more cameras. In one example, the optimal set of cameras is selected based on a lookup table indicating a next set of cameras to use (e.g., in a particular situation). In some examples, the lookup table may be populated based on a distance that a location is from device 300. For example, a first order of possible sets of cameras may be used that prioritizes short distances between cameras (e.g., small baselines) when the location is within a certain distance from device 300 while a second order of possible sets of cameras may be used that prioritizes large distances between cameras (e.g., large baselines) when the location exceeds a certain distance from device 300. In some examples, the lookup table is generated (e.g., established) before any image is captured by cameras 310. In other examples, the lookup table is generated (e.g., established) based on images received by cameras 310, such as by learning how to best respond to issues encountered by a specific configuration of cameras on device 300.

In some examples, the optimal set of cameras is selected based on information identified by camera selector 320, such as information indicating a context of device 300 (e.g., a speed, acceleration, path, weather, time of day, or the like). In such examples, images used for selecting the optimal set may be captured while device 300 is moving.

In some examples, feature comparison operations are simultaneously occurring with respect to multiple different sets of cameras to determine which set of camera for depth processor 330 to use. In some examples, different sets of cameras are capturing images at different rates and/or resolution to lower the computational cost of performing multiple feature comparison operations at the same time. In such examples, some feature comparison operations are used for diagnostic operations while other feature comparison operations are used by depth processor 330 for calculating depth, where feature comparison operations for diagnostic operations are performed at a lower rate than those used by depth processor 330.

In some examples, different sets of cameras are alternated between at a rate quicker than is needed for determination purposes. In such examples, a particular set of cameras captures images at the rate that is needed for determination purposes and the other set of cameras are capturing images between when the particular set of cameras are capturing images to be used to determine when to switch to the other set of cameras.

In some examples, camera selector 320 determines whether a location for which device 300 needs depth information is near or far away to device 300. In such examples, camera selector 320 may cause one or more cameras to capture images in less resolution when the location is closer and more resolution when the location is further away.

After a new set of one or more cameras is used, camera selector 320 may determine whether the new set is able to determine sufficient information for a location. In some examples, when the new set is able to be used to determine sufficient information for the location, device 300 may perform one or more operations based on the information for the location, such as navigating device 300 in the physical environment. In some examples, when the new set is not able to be used to determine sufficient information for the location, camera selector 320 may select a different set of one or more cameras based on one or more techniques discussed above. In such examples, camera selector 320 may continue to select different sets of one or more cameras until either sufficient information is determined for the location or a threshold number of sets of cameras were tried. In some examples, when a threshold number of sets of one or more cameras are tried and information is still needed to make a determination, device 300 may perform an operation other than changing to a different set of one or more cameras to attempt to resolve the issue. Examples of the operation include changing a navigation characteristic of device 300 (e.g., changing from a first path to a second path) or an operation characteristic of device 300 (e.g., reducing a speed of device 300).

In some examples, camera selector 320 is configured to change a mode of a camera from cameras 310, such as changing the camera from standby (e.g., turned off or in a lower power mode) to ready (e.g., turned on or in a mode that is capable of capturing images at a particular rate and/or resolution). In some examples, camera selector 320 predicts that the camera will be needed and changes the camera from standby to ready. In such examples, camera selector 320 may cause the camera to change modes so that the camera may be used by depth processor 330 without having to change modes when it is determined necessary. For example, camera selector 320 may cause a camera to transition to a ready mode before a determination is made that there is either a lack of feature correlation between current images or missing information in a representation of a physical environment.

In some examples, camera selector 320 determines to transition from a current set of cameras to a previous set of cameras, such as a default set of cameras. In such examples, the determination may be based on determining that sufficient information has been determined for the location or a cause of the lack of feature correlation for the previous set of cameras has been resolved (e.g., a predefined amount of time has lapsed, images from the previous set of cameras have been determined to have sufficient feature correlation, or an operation state of device 300 has changed (such as one that could have caused the previous set of cameras to now have sufficient feature correlation)).

FIG. 4A is a block diagram illustrating camera array 400 of three cameras. Camera array 400 includes first camera 410, second camera 420, and third camera 430. In some examples, camera array 400 is attached to a device (e.g., device 300) and configured to capture images of a physical environment. In such examples, a field of view of each camera in camera array 400 may be at least partially overlapping such that all of the cameras are able to capture an image of a particular area of the physical environment. In some examples, first camera 410, second camera 420, and third camera 430 are each oriented in a different direction. In other examples, at least two of first camera 410, second camera 420, and third camera 430 are each oriented in the same direction.

In some examples, first camera 410 and second camera 420 are on a first axis (e.g., a horizontal axis) with a first distance separating each camera. In such examples, third camera 430 may be offset from the other cameras and on a second axis that is different from the first axis. Third camera 430 may be below (as illustrated in FIG. 4A) or above (not illustrated in FIG. 4A) the other cameras. Having cameras at different axes may allow for different cameras to capture a field of view at different angles. In some examples, third camera 430 is a second distance from first camera 410 and a third distance from second camera 420. In such examples, the second and third distance may be the same or different. In some examples, the second distance and/or the third distance may be the same or different as the first distance. Having cameras at different distances from each other may allow for different sets of cameras to have different baselines to change how calculations are performed when processing images for information with respect to the physical environment. In some examples, third camera 430 is offset from a vertical axis associated with first camera 410 and a vertical axis associated with second camera 420, such that third camera 430 is between the vertical axis associated with first camera 410 and the vertical axis associated with second camera 420. As mentioned above, having cameras at different axes may allow for different cameras to capture a field of view at different angles.

FIG. 4B is a block diagram illustrating camera array 440 of four cameras. The camera array includes first camera 450, second camera 460, third camera 470, and fourth camera 480. In some examples, camera array 440 is attached to a device (e.g., device 300) and configured to capture images of a physical environment. In such examples, a field of view of each camera in camera array 440 may be at least partially overlapping such that all of the cameras are able to capture an image of a particular area of the physical environment. In some examples, first camera 450, second camera 460, third camera 470, and fourth camera 480 are each oriented in a different direction. In other examples, at least two of first camera 450, second camera 460, third camera 470, and fourth camera 480 are each oriented in the same direction (e.g., first camera 450 and second camera 460; first camera 450 and third camera 470; or first camera 450 and fourth camera 480).

In some examples, first camera 450 and second camera 460 are on a first axis (e.g., a horizontal axis) with a first distance separating each camera. In such examples, third camera 470 and fourth camera 480 may be offset from the other cameras and on a second axis (e.g., a different horizontal axis that is parallel to the other horizontal axis) that is different from the first axis. Third camera 470 and/or fourth camera 480 may be below (both below is illustrated in FIG. 4B) or above (not illustrated in FIG. 4B) the other cameras. As mentioned above, having cameras at different axes may allow for different cameras to capture a field of view at different angles. In some examples, third camera 470 and fourth camera 480 have a second distance separating each camera. In such examples, the second distance may be the same or different from the first distance. As mentioned above, having cameras at different distances from each other may allow for different sets of cameras to have different baselines to change how calculations are performed when processing images for information with respect to the physical environment. Having sets of cameras at the same distance from each other may allow for different sets of cameras to be easily switched between without changing a capability of the set with respect to capturing objects at a particular distance not withstanding orientation.

In some examples, third camera 470 is a second distance from first camera 450 and a third distance from second camera 460. In such examples, the second and third distance may be the same or different. In some examples, the second distance and/or the third distance may be the same or different as the first distance. In some examples, third camera 470 is along a vertical axis associated with first camera 450 and offset but parallel from a vertical axis associated with second camera 460, such that third camera 470 is below first camera 450 and diagonal to second camera 460. Having sets of cameras along the same axis from each other may allow for different sets of cameras to be easily switched between without changing a capability of the set with respect to capturing objects at a particular viewpoint.

In some examples, fourth camera 480 is a fourth distance from second camera 460 and a fifth distance from third camera 470. In such examples, the fourth and fifth distance may be the same or different. In some examples, the fourth distance and/or the fifth distance may be the same or different as the first, second, or third distance. In some examples, fourth camera 480 is along a vertical axis associated with second camera 460 and offset from a vertical axis associated with first camera 450, such that fourth camera 480 is below second camera 460 and diagonal to first camera 450. In some examples, small angular differences in mounting positions of cameras lead to different effects on the cameras. In such examples, when one camera experiences a particular effect, another camera is less likely to suffer the same problem, making the system more robust.

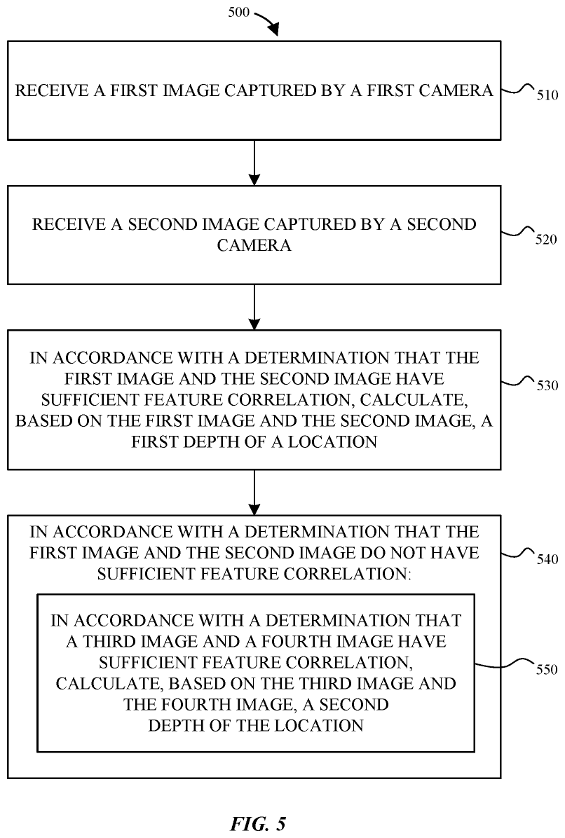

FIG. 5 is a flow diagram illustrating method 500 for calculating a depth of a location. Some operations in method 500 are, optionally, combined, the orders of some operations are, optionally, changed, and some operations are, optionally, omitted.

In some examples, method 500 is performed at a compute system (e.g., compute system 100) that is in communication with a camera (e.g., a camera of cameras 310, first camera 410, or first camera 450). In some examples, the compute system and the camera are included in a device (e.g., device 200 or device 300). In some examples, the device includes one or more actuators and/or one or more sensors other than the camera. In some examples, the camera is connected via at least one or more wires to the one or more processors of the device; in some examples, the camera is wirelessly connected to the one or more processors of the device; in some examples, the one or more processors are included in a component of the device separate from the camera; in some examples, the one or more processors are included in the camera; in some examples, a plurality of processors of a device perform the method, where at least one step is performed by one or more processors on a first system on a chip (i.e., SoC) and a second step is performed by a second SoC, and where the first SoC and the second SoC are distributed in different locations on the device, where the different locations are separated by at least 12 inches. In some examples, method 500 is performed while a device including the camera is performing an operation, such as navigating a physical environment.

At 510, method 500 includes receiving a first image (e.g., a representation of a physical environment with one or more color channels (e.g., red, green and blue color channels) captured by a first camera (e.g., compute system 100, first subsystem 210, a camera of cameras 310, first camera 410, or first camera 450).

At 520, method 500 includes receiving a second image captured by a second camera (e.g., compute system 100, first subsystem 210, a camera of cameras 310, second camera 420, or second camera 460), wherein the second camera is different from the first camera, and wherein the first camera and the second camera are established as a first set of cameras (e.g., a camera pair) for calculating a depth of a location (e.g., a point location) (in some examples, the device includes the first camera and the second camera; in some examples, the first image is captured before or after the first set of cameras is established; in some examples, receiving the first image includes accessing a memory location using an expected location or a location identified in a message received from the first camera; in some examples, before receiving the first image, the device establishes the first set of cameras for calculating the depth of the location; in some examples, the first set of cameras does not include the third camera; in some examples, the first set of cameras includes one or more cameras in addition to the first camera and the second camera; in some examples, the first set of cameras is established as default (e.g., predefined before the device begins executing an application that requires a depth calculation); in some examples, the first set of cameras is established based on a likelihood that cameras included in the first set of cameras are able to capture an image of the location; in some examples, the second image is captured before or after the first set of cameras is established; in some examples, the second image is captured at the same time (e.g., approximately the same time, such as that the first and second cameras are instructed to capture images at the same time) as the first image; in some examples, receiving the second image include accessing a memory location using an expected location or a location identified in a message received from the second camera).

At 530, method 500 includes, in accordance with a determination that the first image and the second image have sufficient feature correlation for calculating the depth of the location, calculating, based on the first image and the second image, a first depth of the location (in some examples, when the first depth is calculated based on the first image and the second image, there is not a determination that the third image and the fourth image have sufficient feature correlation; in some examples, the device determines that the first image and the second image have sufficient feature correlation for calculating the depth of the location; in some examples, a second device, different from the device, determines that the first image and the second image have sufficient feature correlation for calculating the depth of the location; in some examples, determining that the first image and the second image have sufficient feature correlation includes determining that a threshold number of features can be identified in both images; in some examples, determining that the first image and the second image have sufficient feature correlation includes determining that a depth calculated for the location is similar to an expected depth, such as compared to surrounding depths or a depth calculated for the location at different (e.g., previous) time; in some examples, calculating, based on the first image and the second image, the depth is also based on one or more images other than the first image and the second image; in some examples, calculating the depth includes identifying feature correlation between at least two images (e.g., a corner, edge, or uniquely identifiable portion in the at least two images) over a threshold and then measuring disparity between the at least two images). In some example, method 500 further includes calculating the first depth of the location is not based on an image captured by the third camera (in some examples, the feature correlation for the first depth is not based on an image captured by the third camera, though calibration of the first image and/or the second image is performed based on an image captured by the third camera).

At 540, method 500 includes in accordance with a determination that the first image and the second image do not have sufficient feature correlation (e.g., a lack of feature correlation) for calculating the depth of the location (in some examples, the device determines that the first image and the second image do not have sufficient feature correlation for calculating the depth of the location; in some examples, a second device, different from the device, determines that the first image and the second image do not have sufficient feature correlation for calculating the depth of the location; in some examples, determining that the first image and the second image do not have sufficient feature correlation includes determining that a threshold number of features cannot be identified in both images; in some examples, determining that the first image and the second image do not have sufficient feature correlation includes determining that a depth calculated for the location is different from an expected depth, such as compared to surrounding depths or a depth calculated for the location at different (e.g., previous) time). In some examples, the determination that the first image and the second image do not have sufficient feature correlation for calculating the depth of the location includes identifying a feature (e.g., an object or a portion of an object, such as an edge) in the first image that is not included in the second image. In some examples, the determination that the first image and the second image do not have sufficient feature correlation for calculating the depth of the location includes identifying a fault in the first image (in some examples, the fault is lens flare or an electrical/software fault). In some examples, the determination that the first image and the second image do not have sufficient feature correlation for calculating the depth of the location includes a determination that a threshold number of features in the first image are not included in the second image, and wherein the threshold number is at least two (in some examples, the determination includes a determination that one or more features in the first image are not included in the second image and one or more features in the second image are not included in the second image). In some examples, the determination that the first image and the second image do not have sufficient feature correlation for calculating the depth of the location includes: dividing the first image into a plurality of portions; and in accordance with a determination that a first portion of the plurality of portions does not have sufficient feature correlation: in accordance with a determination that a second portion of the plurality of portions does not have sufficient feature correlation, determining, based on determining that a threshold number of the plurality of portions does not have sufficient feature correlation, that the first image and the second image do not have sufficient feature correlation for calculating the depth of the location, wherein the first portion is different from the second portion (in some examples, the second portion does not overlap the first portion).

At 550, method 500 includes, in accordance with a determination that a third image and a fourth image have sufficient feature correlation for calculating the depth of the location, calculating, based on the third image and the fourth image, a second depth of the location (in some examples, the device determines that the third image and the fourth image have sufficient feature correlation for calculating the depth of the location; in some examples, a second device, different from the device, determines that the third image and the fourth image have sufficient feature correlation for calculating the depth of the location; in some examples, determining that the third image and the fourth image have sufficient feature correlation includes determining that a threshold number of features can be identified in both images; in some examples, determining that the third image and the fourth image have sufficient feature correlation includes determining that a depth calculated for the location is similar to an expected depth, such as compared to surrounding depths or a depth calculated for the location at different (e.g., previous) time), wherein: the third image is captured by a third camera (in some examples, the third camera is in an inactive state (e.g., lower power mode, off, capturing images less often, or capturing images with less resolution) while the first set of cameras pair is in an active state; in some examples, the third camera is in an active state (e.g., similar to the first and second cameras) but is not being used for computing the depth of the location), the third camera is different from the first camera, the third camera is different from the second camera, the fourth image is captured by a fourth camera (in some examples, the fourth camera is the first or the second camera; in some examples, the fourth camera is different from the first and the second camera), the fourth camera is different from the third camera, and the third camera and the fourth camera are established as a second set of cameras for calculating the depth of the location (in some examples, the device includes the third camera and the fourth camera; in some examples, the third image is captured before or after the second set of cameras is established; in some examples, the third image is received by the device by accessing a memory location using an expected location or a location identified in a message received from the third camera; in some examples, before receiving the third image, the device establishes the second set of cameras for calculating the depth of the location; in some examples, the second set of cameras does not include the first and/or the second camera; in some examples, the second set of cameras includes one or more cameras in addition to the third camera and the fourth camera; in some examples, the second set of cameras is established based on a likelihood that cameras included in the second set of cameras are able to capture an image of the location; in some examples, the fourth image is captured before or after the second set of cameras is established; in some examples, the fourth image is captured at the same time (e.g., approximately the same time, such as that the third and fourth cameras are instructed to capture images at the same time) as the third image; in some examples, receiving the fourth image includes accessing a memory location using an expected location or a location identified in a message received from the fourth camera; in some examples, after determining that the first image and the second image do not have sufficient feature correlation, the second set of cameras is established; in some examples, the second set of cameras is established in response to determining that the depth of the location is required; in some examples, the third image is captured before or after the second set of cameras is established; in some examples, the third image is captured at the same time (e.g., approximately the same time, such as that all three cameras are instructed to capture images at the same time) as the first image and/or the second image; in some examples, receiving the third image includes accessing a memory location using an expected location or a location identified in a message received from the third camera). In some examples, method 500 further includes calculating the second depth of the location is further in accordance with a determination to select the second set of cameras from a plurality of different sets of cameras (in some examples, the plurality of different sets of cameras does not include the first set of cameras). In some examples, the determination to select the second set of cameras is based on an image captured by the third camera while the third camera is in a lower power mode (in some examples, the lower power mode is an off mode) than a camera in the first set of cameras. In some examples, the determination to select the second set of cameras is based on a priority order of sets of cameras, and wherein the priority order is established before the first image is received. In some examples, the third camera is in a standby mode (e.g., a lower-power or off mode) when the determination that the first image and the second image does not sufficient feature correlation for calculating the depth of the location is made. In some examples, an image captured by the third camera is used to calibrate feature correlation between the first image and the second image. In some examples, the third camera is the first camera. In some examples, calculating, based on the third image and the fourth image, the second depth is in accordance with a determination that the first image and the second image do not have sufficient feature correlation (e.g., a lack of feature correlation) for calculating the depth of the location.

In some examples, method 500 further includes in accordance with the determination that the first image and the second image do not have sufficient feature correlation (e.g., a lack of feature correlation) for calculating the depth of the location, in accordance with the determination that the third image and the fourth image do not have sufficient feature correlation (e.g., a lack of feature correlation) for calculating the depth of the location, and in accordance with a determination that a fifth image and a sixth image have sufficient feature correlation for calculating the depth of the location, calculating, based on the fifth image and the sixth image, a third depth of the location (in some examples, the device determines that the fifth image and the sixth image have sufficient feature correlation for calculating the depth of the location; in some examples, a second device, different from the device, determines that the fifth image and the sixth image have sufficient feature correlation for calculating the depth of the location), wherein: the fifth image is captured by a fifth camera (in some examples, the fifth camera is in an inactive state (e.g., lower power mode, off, capturing images less often, or capturing images with less resolution) while the first set of cameras and/or the second set of cameras is in an active state; in some examples, the fifth camera is in an active state (e.g., similar to the first and second cameras) but is not being used for computing the depth of the location), the fifth camera is different from each of the first camera, the second camera, the third camera, and the fourth camera, the sixth image is captured by a sixth camera (in some examples, the fourth camera is the first or the second camera; in some examples, the fourth camera is different from the first and the second camera), the sixth image is not captured by the fifth camera, and the fifth camera and the sixth camera are established as a third set of cameras for calculating the depth of the location (in some examples, the third set of cameras is different from the first set of cameras and the second set of cameras).

In some examples, method 500 further includes, in accordance with the determination that the first image and the second image do not have sufficient feature correlation (e.g., a lack of feature correlation) for calculating the depth of the location and in accordance with a determination that the seventh image and the eighth image have sufficient feature correlation for calculating the depth of the location, calculating, based on the seventh image and the eighth image, a fourth depth of the location (in some examples, the device determines that the seventh image and the eighth image have sufficient feature correlation for calculating the depth of the location; in some examples, a second device, different from the device, determines that the seventh image and the eighth image have sufficient feature correlation for calculating the depth of the location), wherein: the seventh image is captured by a seventh camera (in some examples, the seventh camera is in an inactive state (e.g., lower power mode, off, capturing images less often, or capturing images with less resolution) while the first set of cameras pair is in an active state; in some examples, the seventh camera is in an active state (e.g., similar to the first and second cameras) but is not being used for computing the depth of the location), the eighth image is captured by the seventh camera (in some examples, the fourth camera is the first or the second camera; in some examples, the fourth camera is different from the first and the second camera).

In some examples, method 500 further includes, in accordance with a determination that the cause of the lack of feature correlation with respect to the first set of cameras has been resolved (in some examples, the determination includes an amount of time passing; in some examples, the determination includes a determination based on an image (such as an image from a camera from the first set of cameras or an image from a camera not included in the first set of cameras)), calculating, based on an image captured by the first camera and an image captured by the second camera, a depth of a location (in some examples, the first set of cameras are not used until it is determined that the cause of the lack of feature correlation with respect to the first set of cameras has been resolved; in some examples, the calculating is for a new location; in some examples, the calculating is for the same location as before).

In some examples, techniques described above are performed in a system for calculating a depth of a location. In such examples, the system comprises: the first camera, the second camera, the third camera, and the fourth camera, wherein the first camera and the second camera are on a first axis, and wherein the third camera and the fourth camera on a second axis different from the first axis (in some examples, the first axis and the second axis are parallel; in some examples, the first camera and the third camera are on a third axis, the second camera and the fourth camera are on a fourth axis, and the third axis is parallel to the fourth axis; in some examples, the first axis and the third axis are perpendicular).

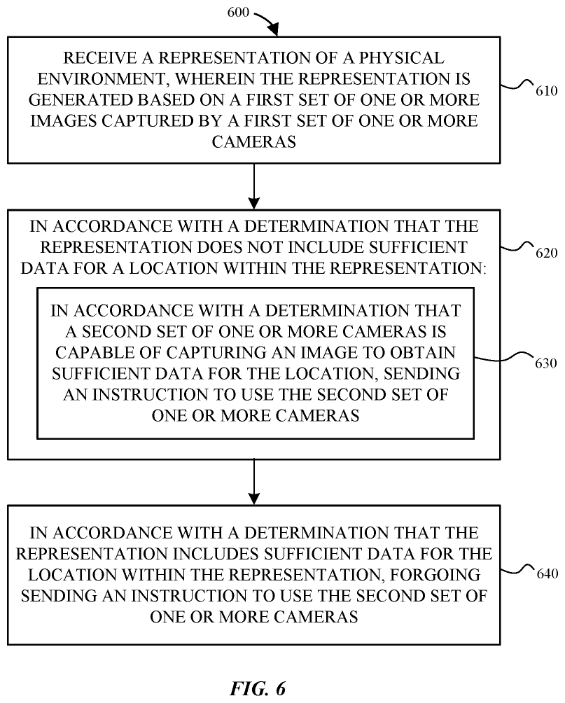

Note that details of the processes described below with respect to method 600 (i.e., FIG. 6) are also applicable in an analogous manner to method 500 of FIG. 5. For example, method 500 optionally includes one or more of the characteristics of the various methods described below with reference to method 600. For example, calculating the second depth of the location from method 500 may be further in accordance with a determination that a representation (e.g., a three-dimensional representation) includes sufficient data for the location within the representation.

FIG. 6 is a flow diagram illustrating method 600 for obtaining sufficient data with respect to a physical environment. Some operations in method 600 are, optionally, combined, the orders of some operations are, optionally, changed, and some operations are, optionally, omitted.

In some examples, method 600 is performed at a compute system (e.g., compute system 100) that is in communication with a camera (e.g., a camera of cameras 310, first camera 410, or second camera 460). In some examples, the compute system and the camera are included in a device (e.g., device 200 or device 300). In some examples, the device includes one or more actuators and/or one or more sensors other than the camera. In some examples, the camera is connected via at least one or more wires to the one or more processors of the device; in some examples, the camera is wirelessly connected to the one or more processors of the device; in some examples, the one or more processors are included in a component of the device separate from the camera; in some examples, the one or more processors are included in the camera; in some examples, a plurality of processors of a device perform the method, where at least one step is performed by one or more processors on a first system on a chip (i.e., SoC) and a second step is performed by a second SoC, and where the first SoC and the second SoC are distributed in different locations on the device, where the different locations are separated by at least 12 inches. In some examples, method 600 is performed while a device including the camera is performing an operation, such as navigating a physical environment.

At 610, method 600 includes receiving a representation (e.g., a world representation, a virtual representation, an object-view representation, a three-dimensional representation) of a physical environment (in some examples, the representation is not an image), wherein the representation is generated based on a first set of one or more images (e.g., a representation of a physical environment with one or more color channels (e.g., red, green and blue color channels) captured by a first set of one or more cameras (e.g., cameras 310, first camera 410, or first camera 450) (in some examples, the representation is generated based on one or more depth calculations, one or more lidar images, one or more depth maps, or any combination thereof; in some examples, the representation includes a representation of an object that has been identified to include one or more characteristics associated with an object of a particular type; in some examples, the device includes the first set of one or more cameras). In some examples, the representation is generated based on a depth map (in some examples, the depth map includes information relating to a distance of a surface on an object in the physical environment). In some examples, the depth map is generated using images captured by a set of one or more cameras (in some examples, the depth map is generated using lidar data; in some examples, the depth map is generated through feature correlation between images).

At 620 and 630, method 600 includes, in accordance with a determination that the representation does not include sufficient data for a location within the representation (in some examples, the determination that the representation does not include sufficient data for a location within the representation includes a determination that the representation does not include (1) any data with respect to the location, (2) enough information to classify an object located at the location, (3) a depth calculation for the location, (4) a sufficient depth calculation (e.g., a current depth calculation has been determined to not be correct), or any combination thereof) and in accordance with a determination that a second set of one or more cameras is capable of capturing an image (e.g., one or more images from each of one or more cameras) to obtain sufficient data for the location, sending an instruction to use the second set of one or more cameras (in some examples, the instruction causes to use one or more images in a field of view corresponding to the location of the representation; in some examples, in accordance with a determination that the second set of one or more cameras is capable of capturing an image to obtain sufficient data for the location, forgoing to initiate an operation (e.g., the operation referred to in paragraph [0089], such as navigating a physical environment) before the representation is updated based on an image from the second set of one or more cameras; in some examples, the second set of one or more cameras includes multiple cameras, wherein an instruction to capture an image is sent to each camera), wherein the second set of one or more cameras is different from the first set of one or more cameras (in some examples, the second set of one or more cameras includes at least one camera not included in the first set of one or more cameras; in some examples, the second set of one or more cameras includes at least one camera included in the first set of one or more cameras). In some examples, the determination that the representation does not include sufficient data for a location within the representation includes performing a geospatial search of the representation (in some examples, the geospatial search includes identifying an area of a physical environment in which the device is moving towards; in some examples, the determination that the representation does not include sufficient data for a location within the representation includes a determination that the representation does not include depth information for a location). In some examples, the second set of one or more cameras consists of two cameras (in some examples, the first set of one or more cameras consists of two cameras). In some examples, a camera of the second set of one or more cameras is in a standby mode (in some examples, the standby mode is a lower-power mode or off) when the determination that the representation does not include sufficient data for a location within the representation is made.

At 640, method 600 includes, in accordance with a determination that the representation includes sufficient data for the location within the representation, forgoing sending an instruction to use the second set of one or more cameras (in some examples, an operation to navigate based on the representation is initiated in addition to forgoing sending the instruction).

In some examples, method 600 further includes, after sending the instruction to use the second set of one or more cameras, sending an instruction to navigate (in some examples, the instruction to navigate identifies a path for the device to take; in some examples, the instruction to navigate identifies a driving characteristic for the device (e.g., a speed)) based on an updated representation of the physical environment, wherein the updated representation is generated based on one or more images captured by the second set of one or more cameras (in some examples, the updated representation is generated based on an image from the first set of one or more cameras); and, in accordance with a determination that the representation includes sufficient data for the location within the representation, sending an instruction to navigate based on the representation of the physical environment (i.e., in this branch, no instruction would be sent to the second set of one or more cameras to capture one or more images).

In some examples, method 600 further includes, before the determination that the representation does not include sufficient data for a location within the representation is made: in accordance with a determination that a camera in the second set of one or more cameras is in a standby mode (in some examples, the standby mode is a lower-power mode or off): in accordance with a determination that the second set of one or more cameras will be needed to update the representation (in some examples, the determination that the second set of one or more cameras will be needed to update the representation is based on a determination that the physical environment (1) is crowded, (2) has a particular weather condition, or (3) is about to change due to navigation of a device), sending an instruction to change the camera to a second mode (e.g., ready, active, or higher-power mode) different from the standby mode.

In some examples, method 600 further includes, in accordance with the determination that the representation does not include sufficient data for the location within the representation: in accordance with a determination based on a current navigation context (in some examples, the current navigation context is a speed of travel or direction of travel), forgoing sending an instruction to use the second set of one or more cameras.

In some examples, the instruction includes a request to capture the one or more images in a first mode (e.g., a higher-power mode or an active mode), and wherein method 600 further comprises: at the device, before sending the instruction, sending a second instruction to use the second set of one or more cameras to capture one or more images in a second mode (e.g., a lower-power mode, such as to capture images in a lower resolution and/or to capture images less often) different from the first mode, wherein the one or more images captured in the second mode are used to determine to send the instruction.

In some examples, method 600 further includes, in accordance with a determination that an updated representation of the physical environment does not include sufficient data for a location within the updated representation, sending an instruction to change a movement characteristic (e.g., lower the speed), wherein the updated representation is generated based on the one or more images captured by the second set of one or more cameras, and wherein the location within the updated representation corresponds to the location within the representation (in some examples, the location within the representation is the same as the location within the updated representation).

Note that details of the processes described above with respect to method 500 (i.e., FIG. 5) are also applicable in an analogous manner to method 600 of FIG. 6. For example, method 600 optionally includes one or more of the characteristics of the various methods described above with reference to method 500. For example, the depth calculated in method 500 may be data included within the representation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the determination information about a physical environment. The present disclosure contemplates that in some instances, this gathered data may include personal information data that uniquely identifies or can be used to identify a specific person and/or a specific location. Such personal information data can include an image of a person, an image of data related to a person, an image of a location, or any other identifying or personal information.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. In addition, policies and practices should be adapted for the particular types of personal information data being collected and/or accessed and adapted to applicable laws and standards, including jurisdiction-specific considerations. Hence different privacy practices may be maintained for different personal data types in each country.

Moreover, it is the intent of the present disclosure that personal information data should be managed and handled in a way to minimize risks of unintentional or unauthorized access or use. Risk can be minimized by limiting the collection of data and deleting data once it is no longer needed.

What is claimed is:

1. A method for obtaining sufficient data to make a decision with respect to a physical environment, the method comprising:
at a device:
receiving a first image captured by a first camera;
receiving a second image captured by a second camera, wherein the second camera is different from the first camera, and wherein the first camera and the second camera are established as a first set of cameras for calculating a depth of a location;
in accordance with a determination that the first image and the second image have sufficient feature correlation for calculating the depth of the location, calculating, based on the first image and the second image, a first depth of the location; and
in accordance with a determination that the first image and the second image do not have sufficient feature correlation for calculating the depth of the location and in accordance with a determination that a third image and a fourth image have sufficient feature correlation for calculating the depth of the location, calculating, based on the third image and the fourth image, a second depth of the location, wherein:
the third image is captured by a third camera,
the third camera is different from the first camera,
the third camera is different from the second camera,
the fourth image is captured by a fourth camera,
the fourth camera is different from the third camera, and
the third camera and the fourth camera are established as a second set of cameras for calculating the depth of the location.

2. The method of claim 1, wherein calculating the first depth of the location is not based on an image captured by the third camera.

3. The method of claim 1, further comprising:
at the device:
in accordance with the determination that the first image and the second image do not have sufficient feature correlation for calculating the depth of the location, in accordance with the determination that the third image and the fourth image do not have sufficient feature correlation for calculating the depth of the location, and in accordance with a determination that a fifth image and a sixth image have sufficient feature correlation for calculating the depth of the location, calculating, based on the fifth image and the sixth image, a third depth of the location, wherein:
the fifth image is captured by a fifth camera,
the fifth camera is different from each of the first camera, the second camera, the third camera, and the fourth camera,
the sixth image is captured by a sixth camera,
the sixth image is not captured by the fifth camera, and
the fifth camera and the sixth camera are established as a third set of cameras for calculating the depth of the location.

4. The method of claim 1, further comprising:
at the device:
in accordance with the determination that the first image and the second image do not have sufficient feature correlation for calculating the depth of the location and in accordance with a determination that the seventh image and the eighth image have sufficient feature correlation for calculating the depth of the location, calculating, based on the seventh image and the eighth image, a fourth depth of the location, wherein the seventh image is captured by a seventh camera, and wherein the eighth image is captured by the seventh camera.

5. The method of claim 1, wherein calculating the second depth of the location is further in accordance with a determination to select the second set of cameras from a plurality of different sets of cameras.

6. The method of claim 5, wherein the determination to select the second set of cameras is based on an image captured by the third camera while the third camera is in a lower power mode than a camera in the first set of cameras.

7. The method of claim 5, wherein the determination to select the second set of cameras is based on a priority order of sets of cameras, and wherein the priority order is established before the first image is received.

8. The method of claim 1, further comprising:
at the device:
in accordance with a determination that the cause of the lack of feature correlation with respect to the first set of cameras has been resolved, calculating, based on an image captured by the first camera and an image captured by the second camera, a depth of a location.

9. The method of claim 1, wherein the determination that the first image and the second image do not have sufficient feature correlation for calculating the depth of the location includes identifying a feature in the first image that is not included in the second image.

10. The method of claim 1, wherein the determination that the first image and the second image do not have sufficient feature correlation for calculating the depth of the location includes identifying a fault in the first image.

11. The method of claim 1, wherein the determination that the first image and the second image do not have sufficient feature correlation for calculating the depth of the location includes a determination that a threshold number of features in the first image are not included in the second image, and wherein the threshold number is at least two.

12. The method of claim 1, wherein the determination that the first image and the second image do not have sufficient feature correlation for calculating the depth of the location includes:
dividing the first image into a plurality of portions; and
in accordance with a determination that a first portion of the plurality of portions does not have sufficient feature correlation and in accordance with a determination that a second portion of the plurality of portions does not have sufficient feature correlation, determining, based on determining that a threshold number of the plurality of portions does not have sufficient feature correlation, that the first image and the second image do not have sufficient feature correlation for calculating the depth of the location, wherein the first portion is different from the second portion.

13. The method of claim 1, wherein the third camera is in a standby mode (e.g., a lower-power or off mode) when the determination that the first image and the second image does not sufficient feature correlation for calculating the depth of the location is made.

14. The method of claim 1, wherein an image captured by the third camera is used to calibrate feature correlation between the first image and the second image.

15. The method of claim 1, wherein the third camera is the first camera.

16. A non-transitory computer-readable storage medium storing one or more programs configured to be executed by one or more processors of a device, the one or more programs including instructions for:
receiving a first image captured by a first camera;
receiving a second image captured by a second camera, wherein the second camera is different from the first camera, and wherein the first camera and the second camera are established as a first set of cameras for calculating a depth of a location;
in accordance with a determination that the first image and the second image have sufficient feature correlation for calculating the depth of the location, calculating, based on the first image and the second image, a first depth of the location; and
in accordance with a determination that the first image and the second image do not have sufficient feature correlation for calculating the depth of the location and in accordance with a determination that a third image and a fourth image have sufficient feature correlation for calculating the depth of the location, calculating, based on the third image and the fourth image, a second depth of the location, wherein:
the third image is captured by a third camera,
the third camera is different from the first camera,
the third camera is different from the second camera,
the fourth image is captured by a fourth camera,
the fourth camera is different from the third camera, and
the third camera and the fourth camera are established as a second set of cameras for calculating the depth of the location.

17. A device, comprising:
one or more processors; and
memory storing one or more programs configured to be executed by the one or more processors, the one or more programs including instructions for:
receiving a first image captured by a first camera;
receiving a second image captured by a second camera, wherein the second camera is different from the first camera, and wherein the first camera and the second camera are established as a first set of cameras for calculating a depth of a location;
in accordance with a determination that the first image and the second image have sufficient feature correlation for calculating the depth of the location, calculating, based on the first image and the second image, a first depth of the location; and
in accordance with a determination that the first image and the second image do not have sufficient feature correlation for calculating the depth of the location and in accordance with a determination that a third image and a fourth image have sufficient feature correlation for calculating the depth of the location, calculating, based on the third image and the fourth image, a second depth of the location, wherein:
the third image is captured by a third camera,
the third camera is different from the first camera,
the third camera is different from the second camera,
the fourth image is captured by a fourth camera,
the fourth camera is different from the third camera, and
the third camera and the fourth camera are established as a second set of cameras for calculating the depth of the location.
